(19) United States
(12) Patent Application Publication
(10) Pub. No.: US 2004/0230914 A1
(43) Pub. Date: Nov. 18, 2004

(54) Displaying view sets of an object for data input

(76) Inventors: Udo Arend, Heidelberg (DE); Edmund Eberleh, St. Leon-Rot (DE); Heinz Willumeit, Leimen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/440,046

(22) Filed: May 16, 2003

(51) Int. Cl. G09G 5/00

(52) U.S. Cl. 715/804

(57) ABSTRACT

A user interface for displaying view sets of an object for data input. The user interface includes a first pane for receiving search criteria for a search among objects, for displaying results of the search and for receiving a selection of an object in the results. The user interface includes a second pane for selecting a view set for the object selected in the first pane. The second pane includes first and second selection mechanisms. The first selection mechanism may be used for selecting between categories of view sets. The second selection mechanism may be used for selecting one of the view sets of the category selected with the first selection mechanism. The user interface includes a third pane for displaying the view set selected in the second pane and for receiving user input of data for the selected object.

### TECHNICAL FIELD

This invention relates to computer user interfaces.

### BACKGROUND

Many computer systems use data objects of considerable size. For example, in the areas of human capital management (HCM) and customer relations management (CRM), objects may be used for representing all relevant data regarding a particular employee or a business partner. In a large organization, the-amount of information stored in such an object may make it impracticable or impossible to present the entire object on a single screen of a typical display used with an HCM system or a CRM system. This poses a problem for designing and maintaining the user interface for computer systems handling large objects.

Earlier user interfaces have attempted to overcome this problem. Some of them use tree structures for the object data. In such systems, the user must navigate through the tree structure to review or edit specific data in the object. Other user interfaces rely on scroll functions or screen changes to display the entire data object. In these systems, the user must scroll the screen or navigate between screens to display the entire data object and edit it.

These approaches are, however, associated with disadvantages. Tree structures may be difficult to overview and use. Some users are averse to scrolling the screen or being subjected to a screen change. A screen that must be scrolled may force the user to memorize parts of the screen when they are scrolled out of view until they become visible again. When a new screen appears, it takes some time for the user to become accustomed to it. Moreover, each of these features may make it difficult to switch from one object to another when doing review or editing.

### SUMMARY OF THE INVENTION

The invention relates to displaying view sets of an object. In a first general aspect, the invention provides a user interface for displaying view sets of an object for data input. The user interface comprises a first pane for receiving search criteria for a search among objects, for displaying results of the search and for receiving a selection of an object in the results. The user interface comprises a second pane for selecting a view set for the object selected in the first pane. The second pane comprises first and second selection mechanisms. The first selection mechanism is used for selecting between categories of view sets, the categories comprising at least a first category of view sets that are associated with performing actions on the selected object and a second category of view sets that are associated with sections of master data for the selected object. The second selection mechanism is used for selecting one of the view sets of the category selected with the first selection mechanism. The user interface comprises a third pane for displaying the view set selected in the second pane and for receiving user input of data for the selected object.

In some embodiments, the first pane comprises first and second database access mechanisms where the second database access mechanism is capable of adding database access patterns to the first database access mechanism.

In some embodiments, the third pane comprises a step bar of interactive step symbols. The step bar may include an indicator after a first step symbol indicating that a selection of a step symbol to follow the first step symbol depends on data received in the first view. The indicator may represent a conditional view or at least two alternative views.

In another general aspect, the invention provides a method of displaying view sets of an object for data input. The method comprises receiving search criteria for a search among objects, displaying results of the search and receiving a selection of an object in the results. A first input is received that selects a category of view sets for the selected object among at least a first category comprising view sets that are associated with performing actions on the selected object and a second category comprising view sets that are associated with sections of master data for the selected object. A second input is received that selects one of the view sets of the category selected in the first input. The view set selected in the second input is displayed for receiving user input of data for the selected object.

In another general aspect, the invention provides computer software, tangibly embodied in at least one of a computer-readable medium and a propagated carrier signal, for displaying view sets of an object for data input. The software comprises instructions to perform operations comprising:

receive search criteria for a search among objects, display results of the search and receive a selection of an object in the results;

receive a first input selecting a category of view sets for the selected object among at least a first category comprising view sets that are associated with performing actions on the selected object and a second category comprising view sets that are associated with sections of master data for the selected object;

receive a second input selecting one of the view sets of the category selected in the first input; and

display the view set selected in the second input for receiving user input of data for the selected object.

Advantages of embodiments of the invention may include one or more of the following. Providing more flexible and efficient review and editing of objects in a single screen. Allowing in-depth review and editing of large objects without using tree structures, scrolling or screen changes. Providing different ways of structuring object data. Providing convenient ways of changing from one object to another without losing the focus of the editing or review. Providing the ability to review basic data of several relevant objects while reviewing or editing the particulars of one object.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a system including a user interface in accordance with the invention;

FIG. 2 is an exemplary screen snapshot of a user interface in accordance with the invention;

FIG. 3 is another exemplary screen snapshot of the user interface in FIG. 2;

FIG. 4 is another exemplary screen snapshot of the user interface in FIG. 2;

FIG. 5 is another exemplary screen snapshot of the user interface in FIG. 2; and

FIGS. 6a-b are flowcharts of exemplary processes that can be performed by the system in FIG. 1.

Like reference symbols in the various drawings indicate like elements.

### DETAILED DESCRIPTION

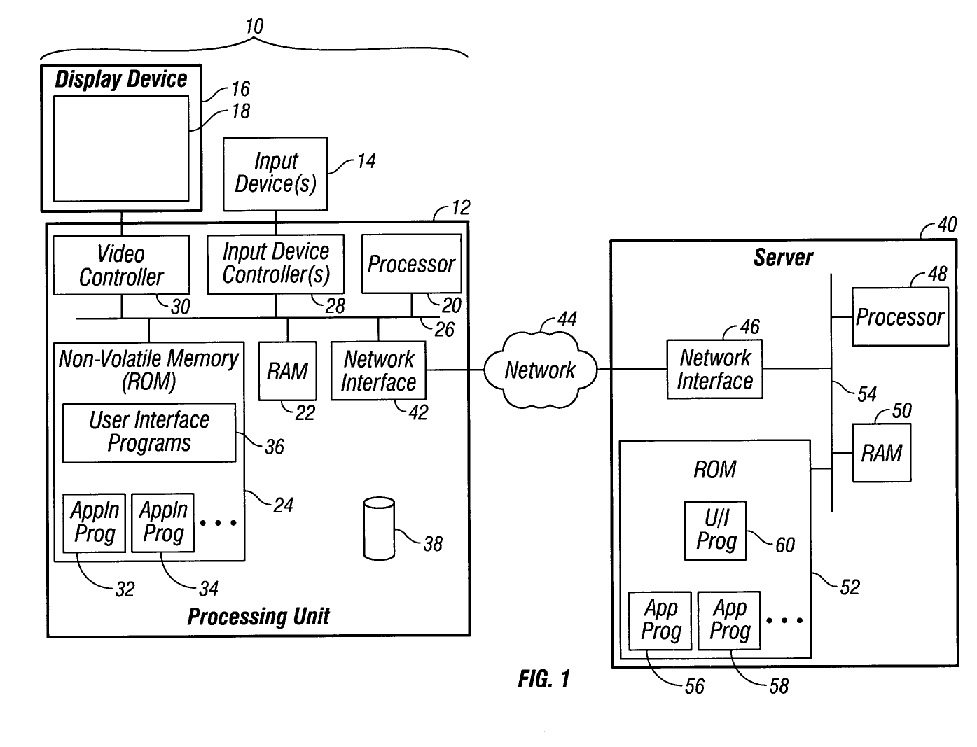

A computer system 10, shown in FIG. 1, includes a processing unit 12, one or more input devices 14, and a display device 16 that may present displays to a user. The display device 16 has a screen 18 upon which the displays may appear.

The processing unit 12 includes a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The computer system 10 is not limited to a personal computer, but could instead include a personal digital assistant, a terminal, a workstation, or other such device.

ROM 24, as is conventional, may provide non-volatile data storage for various application programs 32, 34, etc. Programs 32 and 34 have program instructions that may be loaded into RAM 22 during operation. Processor 20 may then execute the program instructions, as required, to perform particular program functions. Also stored in ROM 24 is a user interface program 36 that may be designed to work in concert with each of the application programs 32, 34, etc. This is conceptually depicted in FIG. 1 by the user interface program 36 being shown as a layer on top of the application programs 32, 34, etc.

With such a design, user interface program modules common to several application programs need not be duplicated in each of the application programs. In addition, such a design may enable a common “look-and-feel” to the user interface for the different program applications 32, 34, etc. The user interface program 36 may create a display in accordance with the invention to be presented to a user on screen 18 of display device 16. The user may interact with the display by providing input using an input device 14, such as a mouse, keyboard, light pen, touchpad, joystick, etc. The user interface program 36 may use the received input to take appropriate actions, such as updating the display, creating a new display, interacting with applications programs 32 and/or 34, accessing a database 38, or accessing server 40 (described below), to list just a few examples. In other implementations, the user interface program 36 need not be a common program or module for more than one program application. Also, the components just described could be combined or separated in various manners, and could be stored in various manners, such as on various non-volatile storage medium.

Also shown in FIG. 1 is server 40. The computer system 10 may access server 40 to run applications residing on the server 40. The computer system 10 may do so by using a network interface 42 connected to its data bus 26 to access a network 44. Network 44 may be, for example, a local area network (LAN), wide area network (WAN), or the Internet. As is conventional, the server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, etc., as well as a common user interface program 60 for the application programs 56, 58, etc. User interface program 60 may operate similarly to user interface program 36. Any of the entities described above in the server ROM 52 could alternatively be located in a separate server, database, or computer system.

The following description is set in the exemplary context of an HCM program application. An HCM program application can manage a company's interactions with its employees, for example hiring new employees, payroll processing, organizational hierarchies, etc. In one implementation, the HCM application program is made up of several different application program modules, some of which reside on a client computer, such as system 10, while others reside on a central server, such as server 40. HCM functions typically generate and require access to a large amount of data that is stored in various databases on a client or server. The data can include personal employee information, job-related employee information, organizational information, and financial or strategic planning information, to list just a few examples. In other implementations, the application program could reside entirely on the client computer system 10 or entirely on server 40.

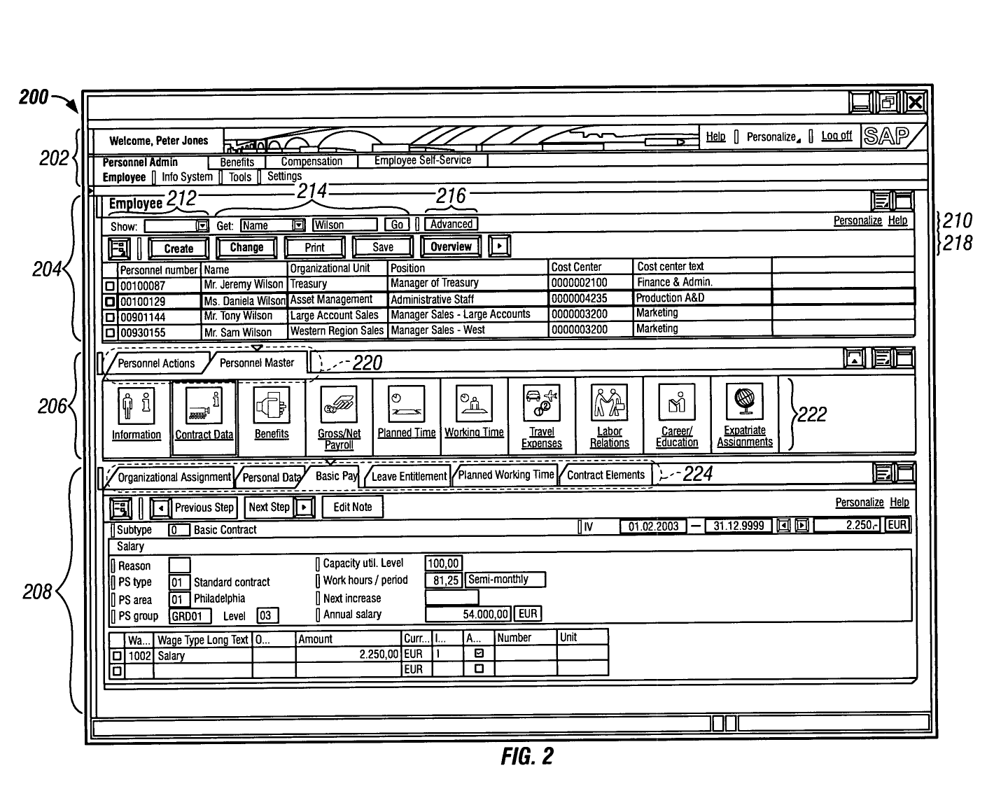

FIG. 2 shows an exemplary user interface 200 that may be presented on screen 18 to a user of an HCM application program. In this example, the program is being used to view and enter personnel administration data. The user may be a person working in the company's human-resources department and may be editing information for one of the company's employees. The employee data may be stored in form of objects, where a unique object having a certain object identification number may be associated with each employee. Typically, such objects have relatively large amounts of data, representing information of several different types. For example, the object for an employee may contain data relating to the work position, the employee's place in the organization, terms of the employment contract, work schedule, payroll information, length of the employment, etc. As will be described below, the user interface 200 offers convenient ways of organizing the display of object data for review or editing.

It will be understood that the examples herein of reviewing or editing existing object data apply similarly to situations where data is entered in a blank object that does not currently contain any data. For example, a company that operates the system may create objects for future employees. When a new employee is hired, a user may enter data into the blank object.

The user interface 200 contains a header section 202 where the user can select between applications. Here, the application Personnel Admin is selected, among other exemplary applications named Benefits, Compensation and Employee Self-Service. The Personnel Admin application offers several screens for the user to choose between: Employee (currently selected), Info System, Tools and Settings.

The user interface 200 contains an object identification pane (OIP) 204, which can be used to search for objects in a database and present the results for review. A view set selection pane (VSP) 206 may be used for selecting which sets of views for an object selected in the OIP 204 should be displayed in the user interface 200. The view sets may be arranged according to categories in the VSP 206 as will be described later. In FIG. 2, an object data pane (ODP) 208 is displayed at the bottom of user interface 200. The ODP 208 displays views where data for the object selected in the OIP 204 can be entered, edited or reviewed. As will be described later, the view sets may be displayed by other panes than the ODP 208. In short, the user interface 200 allows the user to search for and select objects, choose between categories of view sets, select a view set within the chosen category, and select a view within the selected view set and edit it, all in one screen.

As an exemplary operation of the user interface 200, a user may use the OIP 204 to search for an object associated with a particular employee. In FIG. 2, the search was done by name (“Wilson”) and the OIP 204 contains four resulting objects in a list. The user has selected the second object, “Ms. Daniela Wilson”. The OIP 204 contains a search bar 210 that provides database access mechanisms, or search mechanisms, that a user may use to search for objects stored in database 38.

A first search mechanism 212 is a “Show” mechanism containing a drop-down list with a selection of database access patterns, or search patterns, for retrieving collections of database objects. In the current example which uses employee records, the Show mechanism may contain search patterns that the user frequently needs. The Show mechanism may contain search patterns applicable to other objects such as accounts or business partners. For example, the Show mechanism may contain a “My Accounts” search pattern selectable through the drop-down list. The “My Accounts” search pattern triggers a database search seeking those accounts for which the user is responsible. As another example, the Show mechanism may contain a “My Favorites” search pattern that retrieves a collection of one or more objects that the user has previously identified. Activating the “My Favorites” search pattern causes the specific objects to be listed as the search results in OIP 204.

A second search mechanism 214 is a search tool having three parts: a “Get” list box for choosing a field label, a string entry field for providing a search string, and a “Go” button for initiating a database search. The user may choose a field label from the Get list box, provide a search string in the string entry field, and activate the Go button to initiate a database search for objects having the entered search string in the selected field. In this example, the user selected “Name” in the Get list box, entered “Wilson” in the string entry field, and activated the Go button to initiate the search that produced the results shown in FIG. 2.

A third mechanism 216 is an “Advanced” search, which allows a user to define advanced search criteria or edit the search patterns in the Show mechanism 212. These features may be executed through controls displayed in the OIP 204 when the user activates the Advanced search function. For example, the Advanced search function may allow the user to specify more than one field label (in analogy to the single field label selectable in the second search mechanism 214) with a separate search string for each field. As another example, the Advanced search function may allow the user to narrow the class of objects to be searched. In an application where the objects represent accounts, the user may have the search performed on “all accounts,” meaning all accounts that can be included in the database search, or the user can confine the search to customized groups of accounts such as “active accounts,” “my accounts” or “deleted accounts,” to name a few examples. As yet another example, the third mechanism 216 can be used to edit the contents of the Show mechanism 212. The user can specify a search pattern (for example including a search for two strings in different fields of the objects), name the search pattern, and add it to the Show mechanism, where it will be selectable under the specified name.

Thus, the user can enter search criteria through any of the mechanisms 212, 214 and 216 for a search among objects. Basic data of the objects resulting from the search are displayed in the OIP 204. In FIG. 2, for example, the personnel number, name, organizational unit, position and cost center information are displayed for each of the four employees. The user can peruse this basic data for any or all of the objects to identify the objects and verify whether the search produced the desired result.

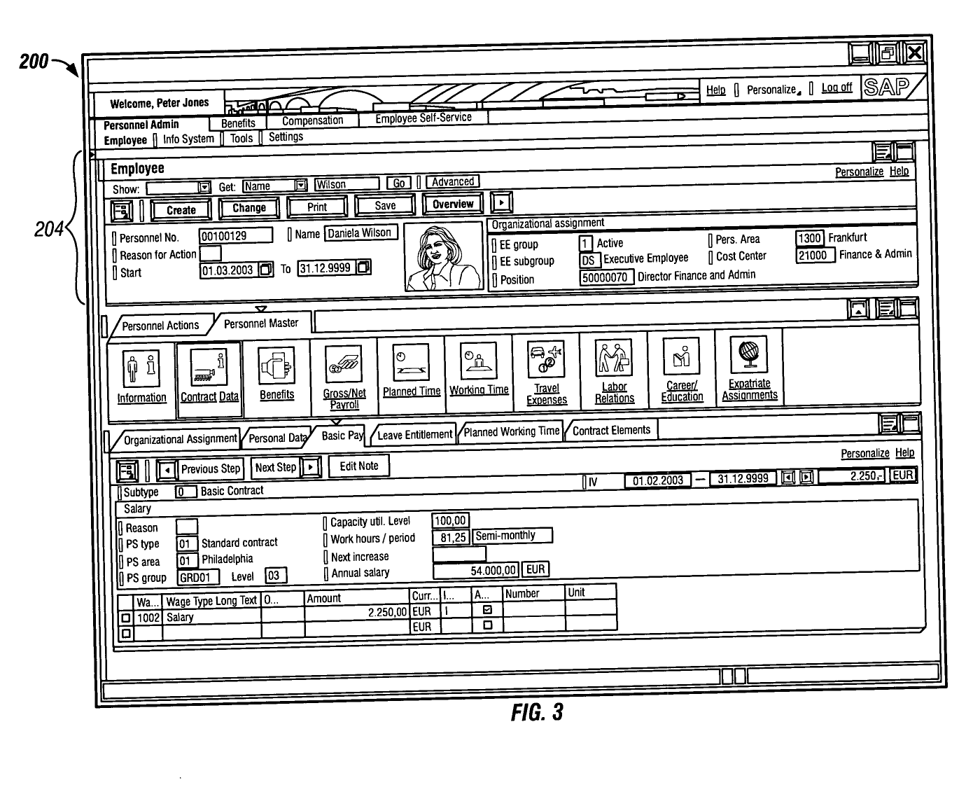

The user can perform some object-oriented operations using functions in toolbar 218. For example, the toolbar 218 allows the user to create new objects for the database using a “Create” button, and to save entered data for the selected object using a “Save” button. At the left end of the toolbar 218 is a button that causes the OIP 204 to switch from displaying a list of search results to displaying a form with data from an object selected in the list. FIG. 3 shows the user interface 200 where the OIP 204 displays basic data for the employee Daniela Wilson, which is the object selected in the OIP's list (FIG. 2). The OIP 204 in FIG. 3 displays more data, yet not all available data, of the selected object. The OIP 204 can be switched back to displaying the search-result objects in a list (as shown in FIG. 2) using the same button.

With reference again to FIG. 2, the VSP 206 is used to select a view set for the object selected in the OIP 204. The VSP contains a category selection function 220 and a view set selection function 222. The category selection function 220 may contain several categories of view sets and here contains the exemplary categories Personnel Actions and Personnel Master. Currently, the Personnel Master category is selected in the category selection function, and the Contract Data view set is selected in the view set selection function. The view set selected in the VSP 206 determines the views to be displayed in the ODP 208. Here, the ODP 208 contains the following views 224 that are included in the Contract Data view set: Organizational Assignment, Personal Data, Basic Pay (currently selected), Leave Entitlement, Planned Working Time and Contract Elements. The currently selected view Basic Pay contains a number of fields with data for the selected object. The user may edit any of the data or enter new data as appropriate. The user may select any of the views 224 using their respective tab at the top of the view. The user may also move to the next or previous step of the data entry (that is, the next or previous view) by using the buttons labeled accordingly in the ODP 208.

In FIG. 2, the view set selection function 222 displays icons for the view sets that belong to the category selected with the category selection function 220; in this example, the view sets belonging to the Personnel Master category. Those view sets are: Information, Contract Data (currently selected), Benefits, Gross/Net Payroll, Planned Time, Working Time, Travel Expenses, Labor Relations, Career/Education and Expatriate Assignments. Each of these exemplary view sets covers a section of the master data for the selected object. Different view sets may be used in applications where other objects are used.

Thus, to review or edit data in a particular section of the master data for an employee, a user would use the OIP 204 to retrieve the object for that employee, use the VSP 206 to select the Personnel Master category and select the appropriate view set. The user may then review or edit the master data in any view of the selected view set using the ODP 208. The user may select views in the ODP 208 using their respective tabs, or the user may activate the next step and previous step buttons.

If the user wishes to review or edit a different section of master data for the same employee, a different view set can be selected in the VSP 206. For example, choosing the Travel Expenses icon in the VSP 206 causes the ODP 208 to display the views of that view set. This offers the user a convenient way of maneuvering through the master data for the selected employee.

As another example, the user may select a different employee in the OIP 204, and the ODP 208 will then display the master data of that employee. Particularly, the category selection function 220 and view set selection function 222 will retain their settings if the user switches object in the OIP 204, giving the user access to the same section of master data for the newly-selected employee. The user may compare or edit the same categories in several customers without navigating through a tree structure and without experiencing screen changes.

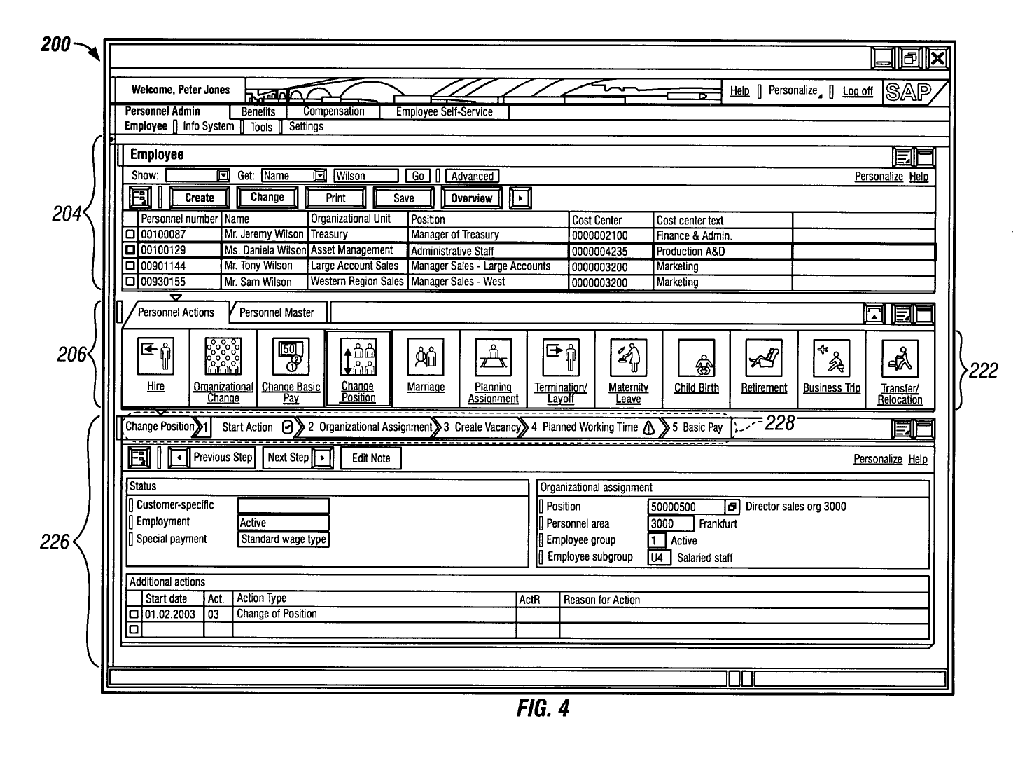

The category selection function 220 contains a tab for another category which will now be described with reference to FIG. 4. When the user selects the Personnel Actions category, different icons appear in the view set selection function 222. As indicated by the category, the view sets corresponding to the icons are associated with actions that can be performed on the object selected in the OIP 204. In this example, the actions are: Hire, Organizational Change, Change Basic Pay, Change Position (currently selected), Marriage, Planning Assignment, Termination/Layoff, Maternity Leave, Child Birth, Retirement, Business Trip and Transfer/Relocation. These are exemplary actions that may be performed with regard to employees. Importantly, performing actions on the employee object may require editing in several sections of the employee's master data. For example, the Change Position action is to be performed when the employee moves into a different position. This may require editing in at least the following sections of the master data (with reference to the Personnel Master view sets in FIG. 2): Contract Data, Benefits, Gross/Net Payroll and Working Time. Accordingly, the view sets in the Personnel Action category contain the views that need to be updated when taking a particular action, and those views may be associated with several different sections of the employee's master data.

The user interface 200 in FIG. 4 does not contain the ODP 208. Instead, it provides guided data entry through a pane 226 (GDP). The GDP 226 contains a step bar 228 which may guide the user through a sequence of entering data. The step bar 228 contains interactive step symbols (consecutively numbered 1-5) representing the respective views in the view set associated with the Change Position icon selected in the VSP 206. The Change Position view set contains the following views: Start Action (currently highlighted), Organizational Assignment, Create Vacancy, Planned Working Time and Basic Pay. The checkmark in the Start Action step symbol indicates that the information contained in the data fields of that view has been processed and accepted. If essential information were missing, a different status indicator may be displayed, such as the warning symbol in the Planned Working Time step symbol.

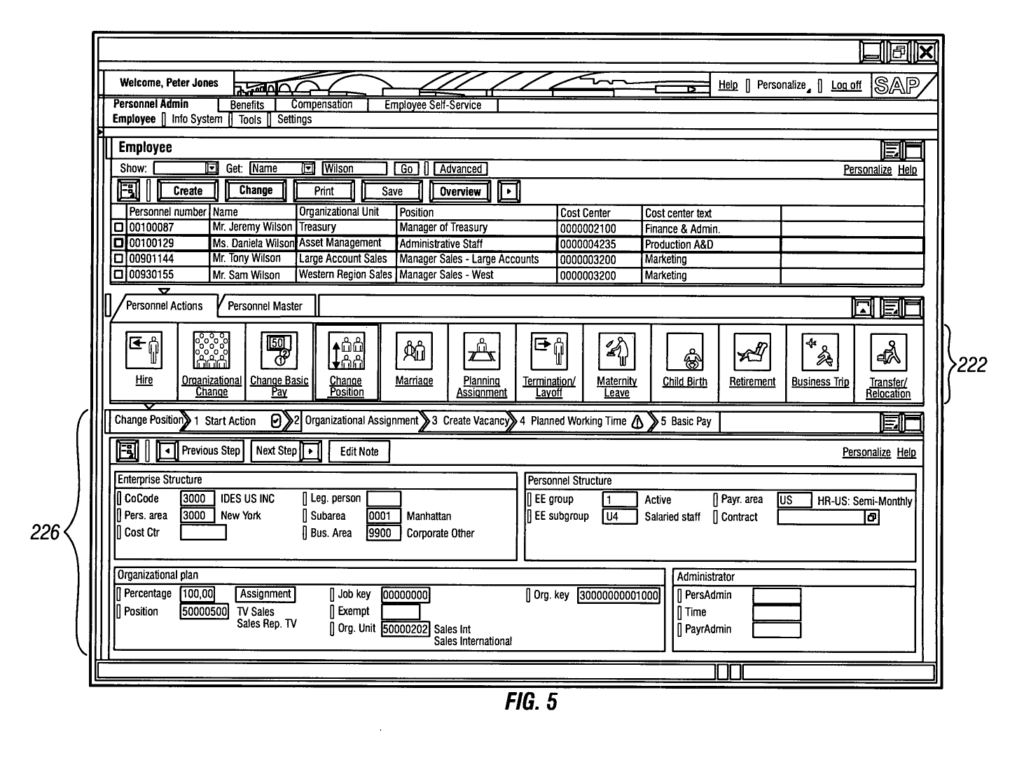

The user may move to the next view, represented by the Organizational Assignment step symbol, by activating that step symbol or by activating the “next step” button. In FIG. 5, the GDP 226 displays the view corresponding to the Organizational Management step in lieu of the one displayed in FIG. 4. The Organizational Assignment view in FIG. 5 contains some data, and the user may enter additional data in the remaining fields.

The user may activate any of the interactive step symbols to display the view corresponding to that step, regardless of which view is currently displayed. If the user does not have a particular piece of information to be entered in a view, the user can nevertheless continue entering the data for that view, and move to a different screen. When the data in a view is processed, the GDP 226 will display the warning symbol in the corresponding step symbol if essential data is missing or not acceptable. The step bar 228 allows the user a convenient way of identifying which steps of the currently selected view set have been successfully completed and which ones are missing essential information.

The GDP 226 may contain views that may or may not be displayed depending on data entered in a previous step of the sequence. For example, if the employer is a multinational company and the new employee is located in a different country than the company's headquarters, some additional data may be required. Initially, the step bar may include a conditional-step indicator representing the views where the user may enter foreign-employee data. The indicator is placed where the conditional steps would appear in the step-symbol sequence. When the user completes the Organizational Assignment view, say, and the data therein is processed, it can be determined whether the new employee is domestic or foreign. In this example, a domestic employee will cause the conditional-step indicator to be removed from the step bar. Similarly, a foreign employee will cause the GDP 226 to replace the conditional-step indicator with step symbols for the conditional steps.

As another example, the sequence in the GDP 226 may have alternative branches of steps. For example, new employees may be hired in staff positions or in management positions. At some place in the sequence, the step bar may display a branch indicator that represents the alternative branches of the sequence. The step bar does not display any step of the alternative branches before it is determined which branch applies to the currently selected employee. When the user specifies which type of position the new employee is assuming, the step bar may replace the branch indicator with the steps symbols of the applicable branch.

When the user has successfully entered the required data in the views of the step bar, the GDP 226 may display a confirmation message. The user may select a different action in the view set selection function 222 if desired. The user may select a different category of view sets, such as the Personnel Master, and select one of its view sets to review or edit data in a section of the employee's master data. The user may select a different employee in the OP 204. In the last example, the VSP 206 will display the currently selected Personnel Action (Change Position) for the new employee. This offers a convenient way of performing similar data entry actions for a number of employees. If the user attempts to select a different view set, category or object while there is unsaved data in the current view set, a confirmation message will alert the user to the risk of losing data. The user may then save the data or proceed without saving the data. The just described flexibility-allowing the user to select a different view, a different view set, a different category of view sets or a different object without scrolling or changing to a different screen—is one of the advantages of the inventive user interface.

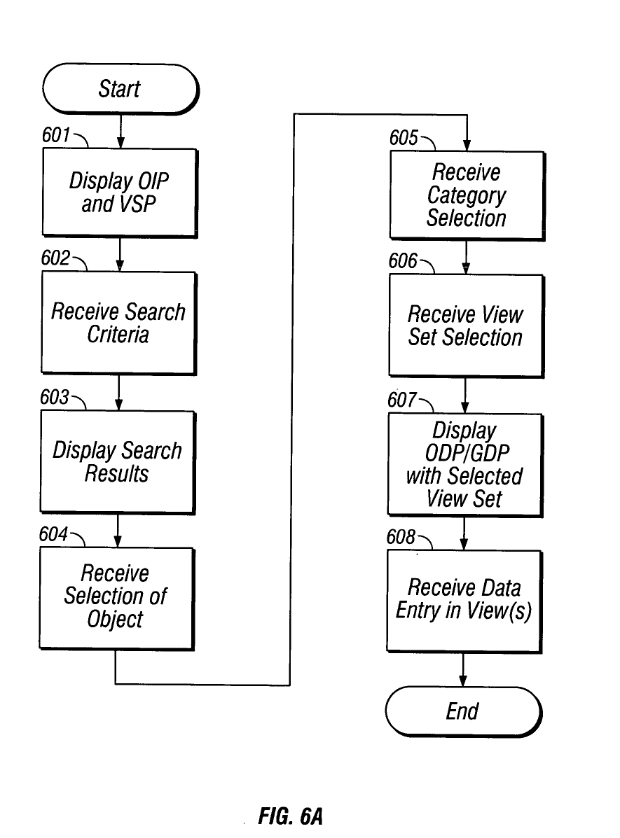

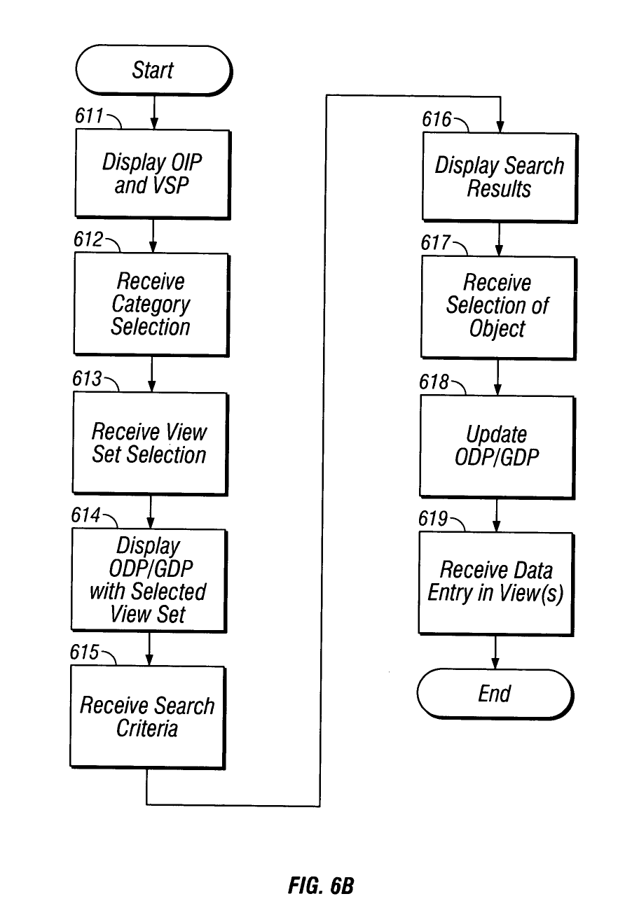

FIG. 6a shows an example of steps that the system in FIG. 1 may perform. In step 601, the user interface program 36 displays an OIP and a VSP in the user interface. They may be displayed as described with regard to the OIP 204 and the VSP 206 in FIG. 2. No ODP or GDP is displayed at this point in the current example.

In step 602, the system receives search criteria for a search among objects. The user may initiate the search using any of the mechanisms 212, 214 and 216 described above. Assuming that at least one object matches the search criteria, the search results are displayed in step 603. The results may be displayed as a list of objects as shown in FIG. 2. The user selects one of the objects in step 604. At any time, the user may switch the OIP from displaying a list of search results to displaying a form with data for a selected object.

In step 605, the system receives the user's selection of a category of view sets. One of the categories may have been selected by default when the VSP was initially displayed in step 601. If the default category is what the user wants, step 605 need not be performed. The user selects a view set in step 606. Depending on the category currently selected, the user may select a view set that is associated with performing actions on the selected object or one that is associated with sections of master data for the selected object. The system displays an ODP or a GDP, as applicable, in step 607. The ODP or the GDP contains the selected view set. In step 608, the user enters data in one or more views of the selected view set. As described above, this may include a guided sequence of entering data in cases involving the GDP 226.

The process need not end after data entry in step 608. The user may select a different view set in the current category, or select a different category and a view set therein, or the user may select a different object in the OIP. Thus, data entry may continue in subsequent steps, and the data may be entered in the currently selected object or in another selected object.

The exemplary process in FIG. 6a illustrates the hierarchical relations between the panes in embodiments of the inventive user interface. By way of analogy, it may be said that the user interface allows the user to approach and work with objects similarly to how the user may handle a book consisting of chapters and pages of text. For example, when the user chooses the Personnel Master category, it is akin to viewing a book by its chapters, where each viewset corresponds to a chapter and where the views are the pages of text in each chapter. Editing (or reviewing) data in a view of a selected view set, then, is similar to editing (or reading) text on a page of a selected chapter. In continuing the analogy, the other categories of view sets are different ways of looking at the book and its contents. For example, when the user selects a view set in the Personnel Actions category to perform an action on the object, the user gets access to several sections of the object data that relate to the selected action. The closest analogy is perhaps to looking up a concept in the index at the back of the book, which quickly gives access to the several pages (perhaps in different chapters) that relate to the concept. Other categories of view sets may provide different ways of approaching and working with objects. For example, a Personnel Reporting category may contain view sets of reporting data for the selected employee.

FIG. 6b is another example of a process that can be performed by the system. The system initially displays an OIP and a VSP in step 611, similarly to step 601 in FIG. 6a. In step 612, the user selects a category in the VSP. In the current example, the user has not yet searched for, or selected, any object in the OIP. The system receives the employee's view set selection in step 613. The system displays an ODP or a GDP, as applicable, in step 614. Because no object has currently been selected, the ODP or GDP contains no object data.

The customer initiates the search for objects in step 615, in analogy with step 602 described above. Similarly, the results are displayed in step 616, and the user selects one of the objects in step 617. The system updates the ODP or the GDP with data from the selected object in step 618. If the user is entering data into an object that currently does not contain any data—as opposed to editing an existing object—step 618 may be omitted.

In step 619, the user enters data in one or more views of the selected view set, in analogy with the description of step 608 above. Similarly, the process need not end after step 619, but may continue with further review or editing of data in the same object or in a different object.

### Embodiments in General

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A user interface for displaying view sets of an object for data input, the user interface comprising:
a first pane for receiving search criteria for a search among objects, for displaying results of the search and for receiving a selection of an object in the results;
a second pane for selecting a view set for the object selected in the first pane, the second pane comprising first and second selection mechanisms, the first selection mechanism used for selecting between categories of view sets, the categories comprising at least a first category of view sets that are associated with performing actions on the selected object and a second category of view sets that are associated with sections of master data for the selected object, and the second selection mechanism used for selecting one of the view sets of the category selected with the first selection mechanism; and
a third pane for displaying the view set selected in the second pane and for receiving user input of data for the selected object.

2. The user interface of claim 1, wherein the first pane displays an identifier and basic data for each object in the results of the search.

3. The user interface of claim 1, wherein the first pane comprises an input function for a user to select between displaying a list of objects resulting from the search and a form for any selected object on the list.

4. The user interface of claim 1, wherein the first pane is capable of receiving the search criteria through:
a first database access mechanism comprising at least one database access pattern, the database access pattern including a predefined search of a database; and
a second database access mechanism comprising at least one selection function for selecting a subset of the database to access and an input function, the second database access mechanism being capable of receiving an input to select a subset of the database, receiving at least one input value in the input function, and searching the subset of the database for objects having the input value, the second database access mechanism also being capable of adding a database access pattern to the first database access mechanism.

5. The user interface of claim 1, wherein the third pane comprises a step bar of interactive step symbols, each step symbol corresponding to one of the views in the selected view set.

6. The user interface of claim 5, further comprising a status indicator on at least one of the step symbols indicating a level of completion of a step represented by the step symbol.

7. The user interface of claim 5, further comprising an indicator after a first step symbol in the step bar indicating that a selection of a step symbol to follow the first step symbol depends on data received in a first view associated with the first step symbol.

8. The user interface of claim 7, wherein the indicator represents a conditional view following the first view, the conditional view being conditioned on the data received in the first view.

9. The user interface of claim 7, wherein the indicator represents at least two alternative views following the first view, wherein a choice between the alternative steps depends on the data received in the first view.

10. The user interface of claim 1, wherein a selection of a new object is received in the first pane, and wherein the third pane displays the selected view set for the new object.

11. A method of displaying view sets of an object for data input, the method comprising:
receiving search criteria for a search among objects, displaying results of the search and receiving a selection of an object in the results;
receiving a first input selecting a category of view sets for the selected object among at least a first category comprising view sets that are associated with performing actions on the selected object and a second category comprising view sets that are associated with sections of master data for the selected object;
receiving a second input selecting one of the view sets of the category selected in the first input; and
displaying the view set selected in the second input for receiving user input of data for the selected object.

12. The method of claim 11, wherein a selection of a different view set in the selected category is received, further comprising displaying the different view set.

13. The method of claim 11, wherein a selection of a different category and a selection of a view set of the different category are received, further comprising displaying the view set of the different category.

14. The method of claim 11, wherein a selection of a different object in the results is received, further comprising displaying the view set selected in the second input for receiving user input of data for the different object.

15. Computer software, tangibly embodied in at least one of a computer-readable medium and a propagated carrier signal, for displaying view sets of an object for data input, the software comprising instructions to perform operations comprising:
receive search criteria for a search among objects, display results of the search and receive a selection of an object in the results;
receive a first input selecting a category of view sets for the selected object among at least a first category comprising view sets that are associated with performing actions on the selected object and a second category comprising view sets that are associated with sections of master data for the selected object;
receive a second input selecting one of the view sets of the category selected in the first input; and
display the view set selected in the second input for receiving user input of data for the selected object.

16. The computer software of claim 15, wherein a selection of a different view set in the selected category is received, further comprising:
display the different view set.

17. The computer software of claim 15, wherein a selection of a different category and a selection of a view set of the different category are received, further comprising:
display the view set of the different category.

18. The computer software of claim 15, wherein a selection of a different object in the results is received, further comprising:
display the view set selected in the second input for receiving user input of data for the different object.
